(19) United States
(12) Patent Application Publication
(10) Pub. No.: US 2026/0014494 A1
(43) Pub. Date: Jan. 15, 2026

(54) IMPURITY ACQUISITION METHOD AND IMPURITY ACQUISITION APPARATUS FOR ACQUIRING METAL IMPURITIES IN ORGANIC SOLVENTS

(71) Applicant: ORGANO CORPORATION, Tokyo (JP)

(72) Inventors: Kyohei TSUTANO, Tokyo (JP); Shota MORINO, Tokyo (JP)

(73) Assignee: ORGANO CORPORATION, Tokyo (JP)

(21) Appl. No.: 19/108,512

(22) PCT Filed: Jul. 31, 2023
(86) PCT No.: PCT/JP2023/027903

§ 371 Date: Mar. 4, 2025

(30) Foreign Application Priority Data
Sep. 16, 2022 (JP) 2022-147868

(51) Int. Cl. B01D 15/36; B01D 15/20; B01D 15/42; B01J 39/04; B01J 39/20; B01J 49/53

(52) U.S. Cl. CPC B01D 15/362; B01D 15/203; B01D 15/424; B01J 39/04; B01J 39/20; B01J 49/53

(57) ABSTRACT

An impurity acquisition method for acquiring a metal impurity in an organic solvent includes: an adsorption and capture process for passing the organic solvent through an adsorbent to be adsorbed or captured the metal impurity in the organic solvent on the adsorbent, a displacement process for passing ultrapure water or high purity gas through the adsorbent to displace the organic solvent remaining in the adsorbent with the ultrapure water or high-purity gas, and an elution and recovery process for passing an eluent through the adsorbent to be elute or recovered the metal impurity adsorbed on the adsorbent.

### TECHNICAL FIELD

The present application is based on and claims priority from Japanese Patent Application No. 2022-147868, filed on Sep. 16, 2022. This application is incorporated herein by reference in its entirety.

The present invention relates to an impurity acquisition method and impurity acquisition apparatus for acquiring metal impurities in organic solvents.

### BACKGROUND ART

High-purity fluids are used in a manufacturing process of electronic components such as semiconductors. Organic solvents, which are one of the fluids used in the manufacturing process of electronic components, also require high purity (high cleanliness).

Organic solvents contain many more impurities than ultrapure water, but the miniaturization of electronic components requires that impurities in organic solvents be further reduced. And, as the required impurity levels become stricter, the demands on analytical evaluation technology also become stricter.

JP2001-141721A and JP2002-005799A disclose that methods for analyzing organic solvents include a method in which a sample is analyzed by evaporating and concentrating (drying and solidifying) using microwaves.

JP2009-288021A disclose that a method in which a solution containing a chelating agent capable of forming a complex with a metal to be analyzed is passed through a sample, and the solution is concentrated using a packing material capable of capturing the complex, and analyzed the solution.

### SUMMARY OF INVENTION

However, in the methods described in JP2001-141721A and JP2002-005799A, a pretreatment such as evaporation and concentration is carried out in order to perform analysis of low concentration. But the lower the concentration of the impurities, the larger the amount of organic solvent that needs to be recovered in a sampling bottle, which increases the overall cost of analysis.

Furthermore, depending on the type of organic solvents, there are also issues such as safety issues during evaporation operations and bottle transportation, and environmental loads due to the generation of waste liquid.

Furthermore, when analyzing metal impurities in organic solvents, the metals in the organic solvents are not stable in state or are in the form of fine particles, which can lead to the metals adhering to the sampling bottle, resulting in inconsistent analysis values and making it impossible to perform an accurate analysis.

In the method described in JP2009-288021A, the metals to be analyzed are limited to those that can form complexes. Furthermore, further improvements are required in order to analyze low concentrations of metal impurities in organic solvents.

Therefore, a subject of the present invention is to provide an impurity acquisition method and an impurity acquisition apparatus capable of stably and safely acquiring metal impurities at low concentrations in organic solvents.

The present invention is to provide an impurity acquisition method for acquiring a metal impurity in an organic solvent, comprising;
an adsorption and capture process for passing the organic solvent through an adsorbent to be adsorbed or captured the metal impurity in the organic solvent on the adsorbent,
a displacement process for passing ultrapure water or high-purity gas through the adsorbent to displace the organic solvent remaining in the adsorbent with the ultrapure water or high-purity gas, and
an elution and recovery process for passing an eluent through the adsorbent to be elute or recovered the metal impurity adsorbed on the adsorbent.

In addition, the present invention is to provide an impurity acquisition apparatus acquiring a metal impurity in an organic solvent, comprising;
an adsorbent through which the organic solvent is passed and which adsorbs or captures the metal impurity in the organic solvent
a fluid supply line which supplies ultrapure water or high purity gas to the adsorbent to displace the organic solvent remaining in the adsorbent,
an eluent supply line which passes an eluent through the adsorbent to elute and recover the metal impurity adsorbed on the adsorbent.

According to the present invention, it is possible to provide an impurity acquisition method and an impurity acquisition apparatus capable of stably and safely acquiring metal impurities at low concentrations in organic solvents

The objects, features, and advantages of the present invention, both above and otherwise, will become apparent from the detailed description set forth below with reference to the accompanying drawings illustrating the application.

### BRIEF DESCRIPTION OF THE DRAWINGS

FIG. 1 is a flow diagram showing an embodiment of a method for acquiring metal impurities in organic solvents.

FIG. 2 is a flow chart showing another embodiment of a method for acquiring metal impurities in organic solvents.

### DESCRIPTION OF EMBODIMENTS

The following is a detailed description of the embodiment of the invention. This embodiment is an example of implementing the invention, and the invention is not limited to this embodiment.

The method of acquiring metal impurities in organic solvents has an adsorption and capture process, a displacement process, and an elution and recovery process.

The adsorption and capture process is a process in which an organic solvent is passed through an adsorbent to be adsorbed or captured a metal impurity in the organic solvent on the adsorbent.

The organic solvent to be analyzed includes those used in a semiconductor manufacturing process, and specifically, isopropanol, propylene glycol monomethyl ether, propylene glycol monomethyl ether acetate, butyl butyrate, propylene glycol monopropyl ether, cyclohexanone, methyl methoxypropionate, butyl acetate, γ-butyrolactone, 4-methyl-2-pentanol, propylene glycol monoethyl ether, ethyl lactate, cyclopentanone, diisoamyl ether, isoamyl acetate, dimethyl sulfoxide, N-methylpyrrolidone, diethylene glycol, ethylene glycol, dipropylene glycol propylene glycol, ethylene carbonate, propylene carbonate, sulfolane, cycloheptanone, 2-heptanone, isobutyl isobutyrate, undecane, pentyl propionate, isopentyl propionate, ethylcyclohexane, mesitylene, decane, 3,7-dimethyl-3-octanol, 2-ethyl-1-hexanol, 1-octanol, 2-octanol, ethyl acetoacetate, dimethyl malonate, methyl pyruvate, and dimethyl oxalate.

The organic solvent preferably contains metal impurities of one or more elements selected from the group consisting of Li, B, Na, Mg, Al, K, Ca, Ti, V, Cr, Mn, Fe, Co, Ni, Cu, Zn, As, Sr, Mo, Ag, Cd, Sn, Sb, Ba, W, Au, Pb, and Pt, and these metal impurities are present in the form of an ionic impurity, a particulate such as colloidal or monodisperse, and a complex.

The concentration of metal impurity in the organic solvent to be analyzed is not particularly limited, but since the impurity acquisition method of the present invention is particularly effective when the concentration of metal impurity is low, the concentration of metal impurity in the organic solvent to be analyzed is preferably 100 ng/L or less, more preferably 10 ng/L or less, and particularly preferably 1 ng/L or less. When the organic solvent to be analyzed contains metal impurities of multiple elements, the concentration of metal impurity of at least one element may be in the above-mentioned range, or the concentrations of metal impurity of all elements may be in the above-mentioned range.

The adsorbent that adsorbs or captures metal impurities in organic solvents is not particularly limited, and examples thereof include materials having ion exchange groups, such as a monolithic organic porous ion exchanger, a porous membrane, and an ion exchange resin.

The monolithic organic porous ion exchanger are not particularly limited as long as it is a porous material having a skeleton formed from an organic polymer and having a large number of communicating pores between the skeletons that serve as flow paths for the reaction liquid, into which ion exchange groups have been introduced. For example, the monolithic organic porous ion exchanger include the first monolithic ion exchanger described in paragraphs [0019] to [0028] of JP 2010-234357 A.

The first monolithic ion exchanger is obtained by introducing ion exchange groups into a monolith, and it has a continuous macropore structure in which bubble-like macropores overlap each other, and the overlapping portions form openings (mesopores) with an average diameter of 30 to 300 μm, preferably 30 to 200 μm, and particularly 35 to 150 μm in a water-wet state.

The first monolithic ion exchanger can be obtained by carrying out the following steps, as described in paragraphs [0029] to [0051] of JP 2010-234357 A:
Step I: preparing a water-in-oil emulsion by stirring a mixture of an oil-soluble monomer not containing an ion exchange group, a surfactant, and water, and then polymerizing the water-in-oil emulsion to obtain a monolithic organic porous intermediate having a continuous macropore structure and a total pore volume of 5 to 16 ml/g;
Step II: preparing a mixture consisting of a vinyl monomer, a crosslinking agent having at least two vinyl groups in one molecule, an organic solvent in which the vinyl monomer and the crosslinking agent are dissolved but a polymer formed by the polymerization of the vinyl monomer is not dissolved, and a polymerization initiator,
Step III: polymerizing the mixture obtained in Step II while standing still and in the presence of the monolithic organic porous intermediate obtained in Step I to obtain a thick-boned organic porous intermediate having a skeleton thicker than that of the organic porous intermediate; Step IV: introducing ion exchange groups into the thick-boned organic porous intermediate obtained in Step III.

Another example of monolithic organic porous ion exchanger is the second monolith ion exchanger described in paragraphs [0052] to [0061] of JP 2010-234357 A.

The second monolith ion exchanger consists of an aromatic vinyl polymer containing 0.3 to 5.0 mol % of crosslinked structural units among all structural units into which ion exchange groups have been introduced, and is a co-continuous structure consisting of a three-dimensionally continuous skeleton having a thickness of 1 to 60 μm and three-dimensionally continuous pores having a diameter of 10 to 100 μm between the skeletons, with a total pore volume of 0.5 to 5 ml/g, an ion exchange capacity per volume in a water-wet state of 0.3 to 5 mg equivalents/ml, and with the ion exchange groups being uniformly distributed in the porous ion exchanger.

The second monolithic ion exchanger can be obtained by carrying out the following steps, as described in paragraphs [0062] to [0083] of JP 2010-234357 A:
Step I: preparing a water-in-oil emulsion by stirring a mixture of an oil-soluble monomer not containing an ion exchange group, a surfactant, and water, and then polymerizing the water-in-oil emulsion to obtain a monolithic organic porous intermediate having a continuous macropore structure with a total pore volume of more than 16 ml/g and 30 ml/g or less;
Step II: preparing a mixture consisting of an aromatic vinyl monomer, a crosslinking agent having at least two vinyl groups in one molecule, with 0.3 to 5 mol % of the total oil-soluble monomers, an organic solvent in which the aromatic vinyl monomer and the crosslinking agent are dissolved but a polymer formed by the polymerization of the vinyl monomer is not dissolved, and a polymerization initiator;
Step III: polymerizing the mixture obtained in Step II while standing still and in the presence of the monolithic organic porous intermediate obtained in Step I to obtain a co-continuous structure;
Step IV: introducing ion exchange groups into the co-continuous structure obtained in Step III.

A resin (gel type) is synthesized by copolymerizing styrene and divinylbenzene in the presence of a catalyst and a dispersant, and then introducing functional groups. The copolymer has a three-dimensional cross-linked structure, and the matrix has pores (mesopores).

A resin (MR type) is synthesized by adding an organic solvent when copolymerizing styrene and divinylbenzene, and then introducing functional groups. The copolymer has a giant network structure, and the matrix not only has fine pores (mesopores), but also spaces (macropores) formed by the agglomeration of small granular gel particles.

Among these adsorbents, the monolithic organic porous ion exchanger is preferably used for the following reasons.
Compared to other adsorbents, adsorbed or captured metal impurities are more easily eluted by an eluent, and the amount of eluent used can be reduced, making it possible to reduce the amount of the organic solvent to be analyzed passed through the adsorbent.
The rate at which the organic solvent to be analyzed can be passed through can be increased, making it possible to pass a large amount of liquid in a short period of time and greatly shortening the time required for the adsorption and capture steps.
The elution and recovery liquid obtained using the monolithic organic porous ion exchanger as an adsorbent is in an acid-added state, so metals do not adhere to bottles, etc., making it easy to store (keep).

In the adsorption and capture process, the amount of the organic solvent to be analyzed passed through the adsorbent is appropriately selected depending on the content of metal impurities in the organic solvent to be analyzed, the type and thickness of the adsorbent, the flow rate, etc.

In addition, when calculating the content of each metal impurity in the organic solvent to be analyzed from the content of each metal impurity in the eluent (recovered liquid) obtained in the analysis step, the total amount of the organic solvent to be analyzed passed through the adsorbent is required. Therefore, in the adsorption and capture step, the total amount of the organic solvent to be analyzed passed through the adsorbent is measured.

In the adsorption and capture process, the conditions for passing the organic solvent to be analyzed through the adsorbent are not particularly limited, but the passing speed is preferably 2000 h⁻¹ or less, more preferably 1000 h⁻¹ or less, and particularly preferably 200 h⁻¹ or less, in terms of SV (space velocity). Also, the LV (linear velocity) is preferably 1000 m/h or less, and particularly preferably 500 m/h or less. Also, the passing time is appropriately selected depending on the total amount and the passing speed of the organic solvent to be analyzed.

And, in the adsorption and capture process, ionic impurities, colloidal or monodisperse fine particles, and metal impurities present in the form of complexes are captured by the adsorbent.

The displacement process is a process in which the organic solvent remaining in the flow cell in which the adsorbent is stored, particularly within the adsorbent, is displaced after the organic solvent to be analyzed has been passed through in the adsorption and capture process.

Specifically, this process includes passing ultrapure water or high-purity gas through the adsorbent to displace the organic solvent remaining in the adsorbent with ultrapure water or an inert gas.

When the adsorbent is a monolith, the inside of the adsorbent may refer to the spaces in the mesh structure of the monolith (macropores), the pores in the three-dimensional cross-linked structure of the matrix (mesopores), etc.

When the adsorbent is a resin (gel type), the inside of the adsorbent may refer to the pores in the three-dimensional cross-linked structure of the matrix (mesopores), etc.

In the case of resin (MR type), the inside of the adsorbent may refer to the spaces of the gel microbead aggregates (macropores), the pores of the three-dimensional cross-linked structure of the matrix (mesopores), etc.

Ultrapure water means water having a resistivity of 2 MΩ cm or more. The lower the concentration of metal impurities in ultrapure water, the more preferable, but the concentration of metal impurities is less than 1 ng/L, more preferably less than 0.1 ng/L, and particularly preferably less than 0.05 ng/L.

As the high purity gas, a gas with a purity of 99.9% or more is preferable, and a gas with a purity of 99.99% or more is particularly preferable, and the fewer impurities in the gas, the more preferable. The types of gas include inert gas, air (atmosphere), oxygen, etc. Examples of inert gas include rare gases such as nitrogen gas, argon gas, and helium gas. The impurities contained in the high purity gas refer to methane, oxygen, carbon dioxide, water, etc. in the case of inert gas, and to fine particles, moisture, etc. in the case of air and oxygen.

When ultrapure water is used in the displacement process, the amount of ultrapure water passed through the adsorbent is appropriately selected depending on the type and thickness of the adsorbent, the flow rate, etc. The flow conditions when ultrapure water is passed through the adsorbent are not particularly limited, but the flow rate is preferably SV of 20000 h⁻¹ or less, more preferably 10 h⁻¹ or more and 4000 h⁻¹ or less. The LV is preferably 1000 m/h or less, particularly preferably 1 m/h or more and 80 m/h or less. The flow time is appropriately selected depending on the total amount of ultrapure water passed and the flow rate.

When a high purity gas is used in the displacement process, the amount of high purity gas supplied to the adsorbent is appropriately selected depending on the type and thickness of the adsorbent, the supply rate, etc. The supply conditions when supplying the high purity gas to the adsorbent are not particularly limited, but the supply rate is preferably SV of 10000 h⁻¹ or less, particularly preferably 5000 h⁻¹ or less. The supply time is appropriately selected depending on the total supply amount and supply rate of the high purity gas.

In the displacement process, the direction in which the ultrapure water and the high purity gas is flowed is preferably the same as the direction in which the organic solvent is passed in the adsorption and capture process.

By using such a direction, even if the impurities adsorbed to the adsorbent when the ultrapure water or the high purity gas is flowed are desorbed, they can be adsorbed again to the adsorbent on the downstream side.

By the displacement treatment in the displacement process, the organic solvent remaining in the adsorbent is displaced with ultrapure water or an inert gas, and no organic solvent remains in the adsorbent. Therefore, even if an aqueous solution containing an acid is passed through the adsorbent as an eluent in the elution and recovery process, the organic solvent that is reactive with the acid does not come into contact with the acid, and safety is maintained.

The elution and recovery process is a process in which an eluent is passed through the adsorbent in which the organic solvent has been displaced in the displacement process and in which the metal impurities have been adsorbed and captured, and the discharged liquid discharged from the adsorbent, i.e., the metal impurities adsorbed and captured by the adsorbent, is eluted to obtain (recover) a recovered liquid.

The eluent is an aqueous solution containing an acid. The acid contained in the eluent is not particularly limited, and examples thereof include inorganic acids such as nitric acid, sulfuric acid, hydrochloric acid, and phosphoric acid, and organic acids such as methanesulfonic acid. Among these, the acid contained in the eluent is preferably nitric acid, sulfuric acid, or hydrochloric acid, because it easily elutes ionic impurity elements from the adsorbent and a high-purity reagent is required.

The acid concentration in the eluent is not particularly limited, but is preferably 0.1 N or more and 3.0 N or less. The eluent is preferably one in which the concentration of each metal impurity is 100 ng/L or less, more preferably nitric acid or hydrochloric acid in which the content of each metal impurity is 10 ng/L or less, and particularly preferably nitric acid or hydrochloric acid in which the content of each metal impurity is 1 ng/L or less.

It is preferable that the direction in which the eluent is passed in the elution process is opposite to the direction in which the organic solvent is passed in the adsorption and capture process.

Since the amount of impurities in the organic solvent passed through the adsorbent in the adsorption and capture process decreases in accordance with the direction of flow, by passing the eluent in this direction in the concentration process, a high recovery rate can be obtained using a smaller amount of the eluent.

In the elution and recovery process, the metal impurities in the organic solvent to be analyzed that have been adsorbed and captured by the adsorbent are eluted by the eluent and migrate into the eluent, thereby obtaining an eluent (recovered liquid) containing the metal impurities that have been adsorbed and captured by the adsorbent.

The impurity analysis method of the present invention analyzes metal elements in the eluent (recovered liquid) containing metal impurities obtained in the elution and recovery process in the impurity acquisition method of the present invention.

The method for measuring the content of each metal impurity in the eluent and recovered liquid is not particularly limited, and examples thereof include a method using a plasma mass spectrometer (ICP-MS), a plasma emission spectrometer (ICP), an atomic absorption spectrometer, an ion chromatograph, etc. The measurement conditions are appropriately selected.

In the analytical method of the present invention, the content of each metal impurity in the organic solvent to be analyzed is determined from the content of each metal impurity in the eluent and recovered liquid obtained by performing the analysis, the recovered amount of the eluent and recovered liquid, and the total amount of the organic solvent to be analyzed passed through the ion adsorbent in the adsorption and capture process.

Next, an example of an embodiment of the method for acquiring and analyzing metal impurities in an organic solvent of the present invention will be described.

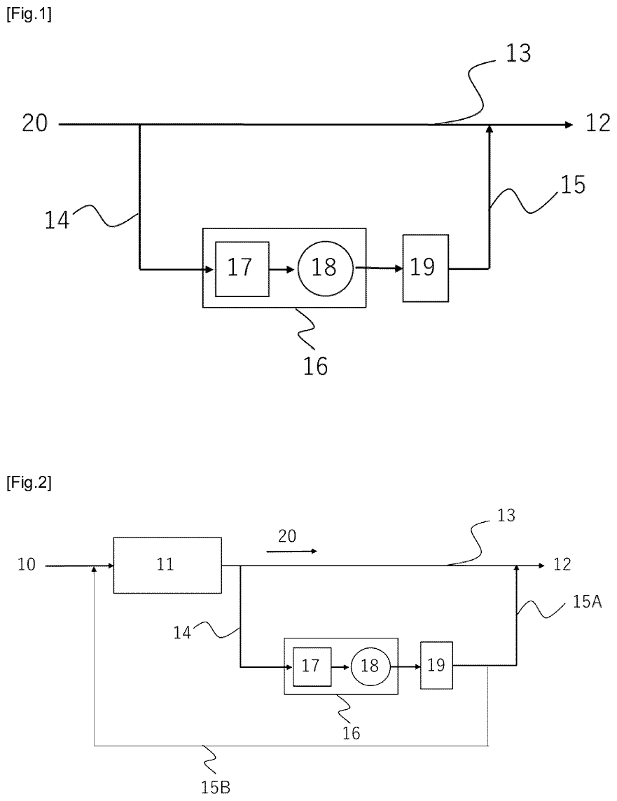

For example, as shown in FIG. 1, an organic solvent supply line 13 through which an organic solvent 20 is supplied to an organic solvent supply destination 12, such as a point of use or an organic solvent storage tank, is configured as follows.

A branch line 14 is connected to the middle of the organic solvent supply line 13. A metal impurity acquisition kit 16 including a flow cell 17 having an adsorbent, preferably a monolithic organic porous ion exchanger, and an integrating flow meter 18 is attached to the branch line 14, and preferably a purification member 19 for purifying the organic solvent is attached to the branch line 14 in the downstream of the metal impurity acquisition kit 16. A return line 15 that returns the organic solvent 20 that has passed through the metal impurity capture kit 16 (or the purification member 19, if a purification member 19 is installed) to the organic solvent supply line 13 is connected downstream of the metal impurity capture kit 16 (or the purification member 19, if a purification member 19 is installed). The other end of the return line 15 is connected to the organic solvent supply line 13 downstream of the portion to which the branch line 14 is connected.

Then, the organic solvent 20 to be analyzed is supplied to the flow cell 17 via the organic solvent supply line 13 and the branch line 14, and the organic solvent 20 is passed through the monolithic organic porous ion exchanger to perform the impurity adsorption and capture process. At this time, the total amount of the organic solvent 20 passing through the flow cell 17 (monolithic organic porous ion exchanger) is measured by the integrating flow meter 18. The organic solvent that has passed through the metal impurity acquisition kit 16 is returned to the organic solvent supply line 13 via a return line 15. The organic solvent that has passed through the metal impurity acquisition kit 16 is returned to the organic solvent supply line 13 via the return line 15. The organic solvent 20 that has passed through the metal impurity acquisition kit 16 may be returned by a pump (not shown) provided inside or outside the metal impurity acquisition kit 16. Next, after a predetermined amount of the organic solvent 20 has been passed through, the metal impurity acquisition kit 16 is removed from the branch line 14. At this time, the metal impurity acquisition kit 16 is removed in a manner that prevents contamination from the outside thereof into the inside thereof, and the inside thereof is sealed. Next, the metal impurity acquisition kit 16 is attached to a displacement apparatus provided at a location different from the organic solvent supply line 13. Ultrapure water or an inert gas, or both, are supplied from the supply unit of the displacement apparatus to the flow cell 17 of the metal impurity acquisition kit 16 in the same direction as the flow direction of the organic solvent in the adsorption and capture process. This performs the displacement process of displacing the organic solvent 20 remaining in the flow cell 17, particularly in the monolithic organic porous ion exchanger. Next, the metal impurity acquisition kit 16 is attached to the elution and recovery apparatus. The eluent is passed from the elution and recovery supply pipe of the elution and recovery apparatus to the flow cell 17 of the metal impurity acquisition kit 16 in a direction opposite to the direction in which the organic solvent is passed in the adsorption and capture process. The elution and recovery process is performed by recovering the eluted and recovered liquid from the metal impurity acquisition kit 16 as it is passed through the monolithic organic porous ion exchanger in the flow cell 17. Next, the content of metal impurities in the elution and recovery liquid is measured, and the analysis process is performed. From the above results, the content of each metal impurity in the organic solvent 20 is calculated.

In this embodiment, the analysis pretreatment kit 16 is configured to include a flow cell 17 having a monolithic organic porous ion exchanger and an integrating flow meter 18. However, the metal impurity acquisition kit 16 may also be configured to include a flow cell 17 having a monolithic organic porous ion exchanger, and the integrating flow meter 18 provided outside (at a subsequent stage) of the analysis pretreatment kit 16. In addition, when removing the metal impurity acquisition kit 16 from the branch line 14, the flow cell 17 equipped with the monolithic organic porous ion exchanger may be removed from the branch line 14, and the integrating flow meter 18 may be left attached to the branch line 14.

Another example is shown in FIG. 2.

As shown in FIG. 2, an organic solvent purification apparatus 11 may be provided to the middle of the organic solvent supply line 13.

In the organic solvent supply line 13 shown in FIG. 2, raw chemical liquid 10 is supplied to the organic solvent purification apparatus 11, and the organic solvent 20 obtained in the organic solvent purification apparatus 11 is supplied to the organic solvent supply destination 12. The branch line 14 is connected to the downstream side of the organic solvent purification apparatus 11, and in the middle of the organic solvent supply line 13, and the metal impurity acquisition kit 16 is attached to the branch line 14. The metal impurity acquisition kit 16 is constructed in the same manner as the metal impurity acquisition kit 16 described in FIG. 1. At the rear of the metal impurity acquisition kit 16, a return line is connected to return the organic solvent 20 that has passed through the metal impurity acquisition kit 16. The other end of this return line 15 may be connected to the downstream side of the organic solvent supply line 13 relative to the portion where the branch line 14 is connected, and the organic solvent may be returned to the organic solvent supply line 13 (return line 15A) or to the upstream side of the organic solvent purification apparatus 11 (return line 15B).

For other points, the explanation in FIG. 1 applies without modification.

The organic solvent purification apparatus 11 shown in FIG. 2 may be any member capable of purifying the organic solvent 20 that has passed through the metal impurity capture kit 16 so that the organic solvent 20 satisfies the standard value of the liquid quality for use in the manufacture of electronic components, and examples of such members include an ion exchange resin and a fine particle removal membrane.

The impurity acquisition method of the present invention, including the adsorption and capture process, the displacement process, and the elution process, and the impurity analysis method of the present invention may all be performed at a place where the organic solvent to be analyzed is produced. Also, the displacement process and the elution process in the impurity acquisition method of the present invention, and the impurity analysis method of the present invention may be performed in a place (apparatus) separate from the adsorption and capture process in the impurity acquisition method of the present invention. In addition, the adsorption and capture process, the substitution process, and the elution process in the impurity acquisition method of the present invention may be performed in the same place (apparatus), and the impurity analysis method of the present invention may be performed in a place (apparatus) different from the place (apparatus) in which these processes are performed. Furthermore, the adsorption and capture process, the displacement process, and the elution process in the acquisition method of the present invention, and the impurity analysis method of the present invention may each be performed in a separate location (apparatus).

Next, in the impurity acquisition apparatus according to the present invention, the embodiment shown in FIG. 1 will be described.

As shown in FIG. 1, the impurity acquisition apparatus for acquiring metal impurities in organic solvents according to the present invention has a metal impurity capture kit 16 equipped with
a flow cell 17 which is connected to a branch line 14 branched from an organic solvent supply line 13 for supplying an organic solvent to be analyzed to a supply destination 12; is provided with an adsorbent; and is passed the organic solvent to be analyzed through the adsorbent and
an integrating flow meter 18 for measuring the amount of the organic solvent to be analyzed that has passed through the flow cell 17, and
a return line 15 that returns the organic solvent that has passed through the integrating flow meter 18 to the organic solvent supply line 13.

The impurity acquisition apparatus may be equipped with a pump inside or outside the metal impurity acquisition kit 16 as a means of returning the organic solvent that has passed through the metal impurity acquisition kit 16

The metal impurity acquisition kit 16 provided in the impurity acquisition apparatus is connected to the organic solvent supply line 13 by the branch line 14 and the return line 15. The organic solvent to be analyzed is sent to the metal impurity acquisition kit 16 via the branch line 14, passes through the metal impurity acquisition kit 16, and is returned to the organic solvent supply line 13 by the return line 15. In this way, in the impurity acquisition apparatus 16 of the present invention, the organic solvent to be analyzed is returned to the organic solvent supply line 13, and the waste liquid is reused, thereby reducing the generation of waste liquid.

As described above, the metal impurity acquisition kit 16 has the flow cell 17 equipped with the adsorbent and the integrating flow meter 18.

The flow cell 17 equipped with the ion adsorbent may be any container that has an inlet and an outlet for passing a liquid and that can house the ion adsorbent, and it is made of resin or metal. The adsorbent provided in the flow cell is the adsorbent explained in the adsorption and capture process in the method for acquiring a metal impurity in an organic solvent, and the monolithic organic porous ion exchanger can be preferably used. The integrating flow meter is not particularly limited as long as it can measure and integrate the amount of liquid introduced.

A purification member 19 may be preferably provided in the rear stage of the metal impurity acquisition kit 16. The purification member 19 is usually provided in the rear stage (outside) of the metal impurity acquisition kit 16, but may also be provided inside the metal impurity acquisition kit 16. The purification member 19 plays a role of purifying the organic solvent that has passed through the flow cell by adsorbing and capturing fine particles and the like other than metal impurities contained in the organic solvent. The purification member 19 is not particularly limited as long as it is used for purifying an organic solvent, and examples of the purification member 19 include an ion exchanger, a microfiltration membrane (MF), an ultrafiltration membrane (UF), and the like. Each of these members may be used alone. Furthermore, these members may be used in any combination.

The metal impurity acquisition kit 16 may have a supply pipe for supplying the organic solvent to be analyzed to the adsorbent in the flow cell; a supply pipe 21 for supplying ultrapure water for displacement or a supply pipe 22 for supplying high purity gas; a supply pipe for supplying elution and recovery liquid; and a discharge pipe 23 for discharging effluent discharged from the adsorbent or a discharge pipe 24 for discharging exhaust gas. The outlet of the integrating flow meter may be used as a discharge pipe for discharging the effluent or exhaust gas to the outside of the metal impurity acquisition kit 16.

The metal impurity acquisition kit 16 is provided with a sealing means for sealing the inside to prevent contamination after the metal impurity acquisition kit 16 is removed from the tube through which the organic solvent to be analyzed is supplied.

### Example

Next, the present invention will be specifically described using an example, but this is merely illustrative and does not limit the present invention.

A second cation-type monolithic ion exchanger was produced in the same manner as in Reference Example 17 described in the Examples of the specification of JP 2010-234357 A. Specifically, the second cation-type monolithic ion exchanger was produced by the method described below. Reference Example 17 described in the Examples of JP 2010-234357 A is incorporated herein by reference in its entirety.

### <Production of Cationic Monolith Ion Exchanger>

### (Step I: Production of Monolith Intermediate)

5.4 g of styrene, 0.17 g of divinylbenzene, 1.4 g of sorbitan monooleate (hereinafter abbreviated as SMO), and 0.26 g of 2,2′-azobis(isobutyronitrile) were mixed and uniformly dissolved. Next, the styrene/divinylbenzene/SMO/2,2′-azobis(isobutyronitrile) mixture was added to 180 g of pure water, and stirred under reduced pressure at a temperature range of 5 to 20° C. using a planetary stirring device, a vacuum stirring and degassing mixer (manufactured by E.M.E., Inc.), to obtain a water-in-oil emulsion. This emulsion was quickly transferred to a reaction vessel, sealed, and polymerized for 24 hours at 60° C. under static conditions. After polymerization was completed, the contents were taken out, extracted with methanol, and then dried under reduced pressure to produce a monolith intermediate having a continuous macropore structure. Observation of the internal structure of the monolith intermediate (dried body) thus obtained by SEM imaging revealed that the walls separating two adjacent macropores were extremely thin and rod-like, but had an open-cell structure. The average diameter of the openings (mesopores) where the macropores overlap each other, measured by a mercury intrusion method, was 70 μm, and the total pore volume was 21.0 ml/g.

### (Production of Co-Continuous Structure Monoliths)

Next, 76.0 g of styrene, 4.0 g of divinylbenzene, 120 g of 1-decanol, and 0.8 g of 2,2′-azobis(2,4-dimethylvaleronitrile) were mixed and dissolved uniformly (Step II).

Next, the monolith intermediate was cut into a disk shape with a diameter of 70 mm and a thickness of about 40 mm, and 4.1 g was collected. The collected monolith intermediate was placed in a reaction vessel with an inner diameter of 110 mm, immersed in the styrene/divinylbenzene/1-decanol/2,2′-azobis(2,4-dimethylvaleronitrile) mixture, degassed in a reduced pressure chamber, and then the reaction vessel was sealed, and the mixture was allowed to polymerize for 24 hours at 60° C. under static conditions. After the polymerization was completed, the monolithic content having a thickness of about 60 mm was taken out, subjected to Soxhlet extraction with acetone, and then dried overnight at 85° C. under reduced pressure (Step III).

The internal structure of the monolith (dried body) thus obtained, which contained 3.2 mol % of a crosslinking component composed of a styrene/divinylbenzene copolymer, was observed by SEM. It was found that the skeleton and pores of the monolith were each three-dimensionally continuous, and the monolith had a co-continuous structure in which the two phases were entangled. The thickness of the skeleton measured from the SEM imaging was 17 μm. The size of the three-dimensionally continuous pores of the monolith measured by mercury intrusion method mercury was 41 μm, and the total pore volume was 2.9 ml/g.

### (Production of Cationic Monolithic Ion Exchanger (CEM) Having Co-Continuous Structure)

The monolith produced by the above method was cut into a cylindrical shape with a diameter of 75 mm and a thickness of about 15 mm. The weight of the monolith was 18 g. 1500 ml of dichloromethane was added to it, heated at 35° C. for 1 hour, cooled to 10° C. or less, and 99 g of chlorosulfuric acid was gradually added, heated and reacted at 35° C. for 24 hours. Methanol was then added to quench the remaining chlorosulfuric acid, and it was washed with methanol to remove dichloromethane and further washed with pure water to obtain a cationic monolith ion exchanger (CEM) having a co-continuous structure.

### (Production of Anionic Monolithic Ion Exchanger)

The CEM produced by the above method was cut into a disk shape with an outer diameter of 70 mm and a thickness of about 15 mm. 1400 ml of dimethoxymethane and 20 ml of tin tetrachloride were added to it, and 560 ml of chlorosulfuric acid was added dropwise while cooling with ice. After the dropwise addition was completed, the temperature was raised to 35° C. and the reaction was carried out for 5 hours to introduce chloromethyl groups. After the reaction was completed, the mother liquor was removed by siphoning and washed with a mixed solvent of THF/water=2/1, and then further washed with THF. This chloromethylated monolithic organic porous material was added with 1000 ml of THF and 600 ml of a 30% aqueous solution of trimethylamine, and reacted for 6 hours at 60° C. After completion of the reaction, the product was washed with a methanol/water mixed solvent, and then washed with pure water to isolate it, thereby obtaining an anionic monolithic ion exchanger (AEM).

### Reference Example 1 Bottle Storage Test

A simulated liquid was prepared so that the concentration of each metal in the organic solvent (IPA) was about 200 ng/L, and stored in a 100 ml PFA bottle. The concentration of each metal impurity in the bottle was measured using an organic solvent ICP-MS (Agilent Technologies, 8900) on the first day (undiluted liquid) (0 day), 3 days, 6 days, 10 days, and 17 days, of storage to evaluate the effect of adsorption of each metal to the bottle.

The evaluation was performed for (1) the simulation liquid and (2) the eluent (recovered raw liquid) obtained by the following procedure. As evaluation results, the rate of change (%) from the concentration on the first day of storage (day 0) for each day that has passed from the first day of storage to 17 days after storage is shown in Table 1. As the evaluation results, the rate of change (%) of the concentration at each elapsed day from the first day of storage to 17 days after the lapse of time relative to the concentration on the first day of storage (day 0) is shown in Table 1.

### (Eluent (Recovered Raw Liquid))

The CEM produced in Production Example 1 was cut into a shape of 10 mm in diameter×50 mm in height and filled into a PFA (tetrafluoroethylene-perfluoroalkyl vinyl ether copolymer) filling container. Next, 100 ml of the simulation liquid was passed through a container filled with CEM at SV=200 h⁻¹, and then 100 ml of 2N nitric acid was passed through the container filled with CEM at SV=200 h⁻¹, and the liquid was recovered in a PFA bottle to be used as an eluent (recovered raw liquid).

TABLE 1

| Test condition | days | Li | Na | Mg | Al | K | Ca | Ti | V | Cr | Mn |
|---|---|---|---|---|---|---|---|---|---|---|---|
| \textcircled{1}Simulated | 3 | >80% | >80% | 53% | 52% | >80% | 60% | 37% | >80% | 77% | 60% |
| liquid | 6 | >80% | >80% | 39% | 36% | >80% | 44% | 25% | >80% | 67% | 48% |
| | 10 | >80% | >80% | 31% | 32% | >80% | 40% | 23% | >80% | 70% | 46% |
| | 17 | >80% | >80% | 28% | 30% | >80% | 33% | 20% | >80% | 79% | 48% |
| \textcircled{2} Eluent | 3 | >80% | >80% | >80% | >80% | >80% | >80% | >80% | >80% | >80% | >80% |
| (recovered | 6 | >80% | >80% | >80% | >80% | >80% | >80% | >80% | >80% | >80% | >80% |
| raw liquid) | 10 | >80% | >80% | >80% | >80% | >80% | >80% | >80% | >80% | >80% | >80% |
| | 17 | >80% | >80% | >80% | >80% | >80% | >80% | >80% | >80% | >80% | >80% |

| Test condition | days | Fe | Ni | Cu | Zn | Mo | Ag | Sn | Ba | Pb |
|---|---|---|---|---|---|---|---|---|---|---|
| \textcircled{1}Simulated | 3 | 44% | 61% | 70% | 48% | 32% | >80% | 39% | 49% | 42% |
| liquid | 6 | 27% | 52% | 53% | 36% | 23% | >80% | 22% | 35% | 27% |
| | 10 | 21% | 51% | 47% | 33% | 27% | >80% | 20% | 29% | 22% |
| | 17 | 16% | 50% | 42% | 33% | 23% | >80% | 16% | 30% | 20% |
| \textcircled{2} Eluent | 3 | >80% | >80% | >80% | >80% | >80% | >80% | >80% | >80% | >80% |
| (recovered | 6 | >80% | >80% | >80% | >80% | >80% | >80% | >80% | >80% | >80% |
| raw liquid) | 10 | >80% | >80% | >80% | >80% | >80% | >80% | >80% | >80% | >80% |
| | 17 | >80% | >80% | >80% | >80% | >80% | >80% | >80% | >80% | >80% |

From the above results, it was confirmed that in the analysis of metal impurities in an organic solvent, the metal impurities in the organic solvent are adsorbed by the ion adsorbent and then recovered in a bottle, which results in no variation in the analytical values of the metal impurities and stable analytical values.

### Example 1

### (Adsorption and Capture Process)

The CEM or AEM produced in Production Example 1 was cut into a shape of 10 mm in diameter×50 mm in height and filled into a PFA-made filling container. Next, 100 ml of the simulation liquid was passed through each container filled with CEM or AEM at SV=200 h⁻¹ so that the concentration of each metal in the organic solvent (IPA) was about 200 ng/L.

### (Displacement Process)

For each container filled with CEM or AEM after passing the liquid, the IPA in the container was displaced by the following two methods.

### Method A (Hereinafter, Listed as “A” in Table 2)

Ultrapure water was passed through the container at 100 ml/min for 30 seconds in the same direction as the simulated liquid, and the IPA in the container was displaced. The container was then purged with N² at 100 ml/min for 1 minute.

### Method B (Hereinafter, Listed as “B” in Table 2)

The container was purged with N² at 100 ml/min for 1 minute in the same direction as the simulated liquid, and the IPA in the container was displaced.

### (Elution, Recovery and Analytical Process)

100 ml of 2N nitric acid was passed through the container in the direction opposite to the simulated liquid or N², at SV=100 h⁻¹, and recovered in a PFA bottle.

The recovered raw liquid was analyzed by ICP-MS (Agilent Technologies, 8900). The results are shown in Table 2.

TABLE 2

| | Displacement | | | | | | | | | | |
|---|---|---|---|---|---|---|---|---|---|---|---|
| Type | process | Li | Na | Mg | Al | K | Ca | Ti | V | Cr | Mn |
| CEM | A | >80% | >80% | >80% | >80% | >80% | >80% | 43% | 31% | 13% | >80% |
| | B | 54% | 49% | 54% | 68% | 59% | 79% | 28% | 12% | 5% | 55% |
| AEM | A | — | — | — | >80% | — | — | >80% | >80% | >80% | >80% |

| | Displacement | | | | | | | | | |
|---|---|---|---|---|---|---|---|---|---|---|
| Type | process | Fe | Ni | Cu | Zn | Mo | Ag | Sn | Ba | Pb |
| CEM | A | >80% | >80% | >80% | >80% | 7% | >80% | >80% | >80% | >80% |
| | B | 50% | 43% | 47% | 22% | 8% | 35% | 34% | 40% | 48% |
| AEM | A | >80% | — | — | — | >80% | >80% | — | — | — |

From the above results, it was demonstrated that when Method A was adopted as the displacement process, the recovery rate of metal impurities was improved. It was also demonstrated that when an AEM was used as the monolith, analysis of metal impurities that cannot be recovered by a CEM was possible.

While several preferred embodiments of the present invention have been shown and described in detail, it will be understood that various changes and modifications can be made therein without departing from the spirit or scope of the appended claims.

### LIST OF REFERENCE NUMERALS

10 Raw Water
11 Organic solvent purification apparatus
12 Organic solvent supply destination
13 Organic solvent supply line
14 Branch line
15, 15A, 15B Return line
16 Metal impurity acquisition kit
17 Flow cell
18 Integrating flow meter
19 Purification member
20 Organic solvent
21 High purity gas supply pipe
22 Ultrapure water supply pipe
23 Gas exhaust pipe
24 Discharge liquid discharge pipe

1. An impurity acquisition method for acquiring a metal impurity in an organic solvent, comprising:
an adsorption and capture process for passing the organic solvent through an adsorbent to be adsorbed or captured the metal impurity in the organic solvent on the adsorbent;
a displacement process for passing ultrapure water or high purity gas through the adsorbent to displace the organic solvent remaining in the adsorbent with the ultrapure water or high-purity gas; and
an elution and recovery process for passing an eluent through the adsorbent to be elute or recovered the metal impurity adsorbed on the adsorbent.

2. The impurity acquisition method according to claim 1, wherein the direction in which the ultrapure water or the high purity gas are flowed in the displacement process is the same as the direction in which the organic solvent is passed in the adsorption and capture process, or the direction in which the eluent is passed in the elution process is opposite to the direction in which the organic solvent is passed in the adsorption and capture process.

3. The impurity acquisition method according to claim 1, wherein the organic solvent passing through the adsorbent is at least a portion of the organic solvent flowing through an organic solvent supply line for supplying the organic solvent from an organic solvent supply source to an organic solvent supply destination.

4. The impurity acquisition method according to claim 3, wherein the organic solvent to be passed through the adsorbent is passed through a purification member which purifies the organic solvent, and the organic solvent purified by the purification member is returned to the organic solvent supply line.

5. The impurity acquisition method according to claim 1, wherein the organic solvent is at least one selected from the group consisting of isopropanol, propylene glycol monomethyl ether, propylene glycol monomethyl ether acetate, butyl butyrate, propylene glycol monopropyl ether, cyclohexanone, methyl methoxypropionate, butyl acetate, γ-butyrolactone, 4-methyl-2-pentanol, propylene glycol monoethyl ether, ethyl lactate, cyclopentanone, diisoamyl ether, isoamyl acetate, dimethyl sulfoxide, N-methylpyrrolidone, diethylene glycol, ethylene glycol, dipropylene glycol propylene glycol, ethylene carbonate, propylene carbonate, sulfolane, cycloheptanone, 2-heptanone, isobutyl isobutyrate, undecane, pentyl propionate, isopentyl propionate, ethylcyclohexane, mesitylene, decane, 3,7-dimethyl-3-octanol, 2-ethyl-1-hexanol, 1-octanol, 2-octanol, ethyl acetoacetate, dimethyl malonate, methyl pyruvate, and dimethyl oxalate.

6. The impurity acquisition method according to claim 5, wherein the concentration of at least one metal element among the metal impurities in the organic solvent is 10 ng/L or less.

7. The impurity acquisition method according to claim 1, wherein the adsorbent is a monolithic organic porous ion exchanger.

8. An impurity acquisition apparatus acquiring a metal impurity in an organic solvent, comprising:
an adsorbent through which the organic solvent is passed and which adsorbs or captures the metal impurity in the organic solvent;
a fluid supply line which supplies ultrapure water or high purity gas to the adsorbent to displace the organic solvent remaining in the adsorbent; and
an eluent supply line which passes an eluent through the adsorbent to elute and recover the metal impurity adsorbed on the adsorbent.

9. The impurity acquisition apparatus according to claim 8, wherein the impurity acquisition apparatus is connected to a branch line branching off from an organic solvent supply line for supplying an organic solvent from an organic solvent supply source to an organic solvent supply destination.

10. The impurity acquisition apparatus according to claim 9, comprising:
a purification member for purifying the organic solvent passed through the adsorbent; and
a return line for returning the organic solvent purified by the purification member to the organic solvent supply line.
